(19) United States
(12) Patent Application Publication
(10) Pub. No.: US 2021/0342241 A1
(43) Pub. Date: Nov. 4, 2021

(54) METHOD AND APPARATUS FOR IN-MEMORY FAILURE PREDICTION

(71) Applicant: Advanced Micro Devices, Inc., Santa Clara, CA (US)

(72) Inventors: Sudhanva Gurumurthi, Austin, TX (US); Vilas K. Sridharan, Boxborough, MA (US)

(73) Assignee: Advanced Micro Devices, Inc., Santa Clara, CA (US)

(21) Appl. No.: 16/862,508

(22) Filed: Apr. 29, 2020

(51) Int. Cl. G06F 11/30; G06F 11/07; G06F 13/16

(52) U.S. Cl. CPC G06F 11/3037; G06F 11/3089; G06F 13/1668; G06F 11/076; G06F 11/0793; G06F 11/3058

(57) ABSTRACT

A method and apparatus for predicting and managing a device failure includes responsive to a predicted failure of a memory device, the predicted failure based on sensor data associated with the memory device, determining a further action for the memory device.

### BACKGROUND

Current and future memories (e.g., dynamic random access memory (DRAM)) are susceptible to a variety of ageing-based failures that are not predictable via error correcting code (ECC) logic. That is, they do not exhibit any known pattern of errors that can be detected/corrected by the ECC before a permanent failure occurs. An example of such a failure mechanism is a Sub-Wordline contact failure in DRAM due to electromigration. Certain types of fault-modes can also evade detection and correction by the ECC when they occur, or require the use of codes with a high overhead.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of an example memory controller in which one or more of the features of the disclosure can be implemented: and

FIG. 3 is a flow diagram of an example method of memory failure prediction.

### DETAILED DESCRIPTION

Although the method and apparatus will be expanded upon in further detail below, briefly a method for predicting memory failure is described herein.

An embodiment of the invention includes an integrated prediction engine implemented in silicon within a memory device predicts impending aging based failures in the device. A prediction (generated by the prediction engine) is created from a combination of data collected from in-memory sensors, (e.g., temperature and voltage sensors), memory error logs, and return-to-manufacturer data at the memory vendor that correlates runtime measurements to predict when a failure may occur.

There is a demonstrated correlation between temperature, voltage, and aging based failures mechanisms. When a failure is predicted, the device conveys this information to a host device via logging/transparency mechanisms to trigger any remedial action schemes (RAS) actions, (e.g., post-package repair). The prediction engine may be in communication with the host processor via an interface that allows the predictor to be updated via firmware updates. For example, such an update may be performed if the vendor identifies new failure modes and desires to update the prediction engine with these modes. The predictor may be implemented using machine learning techniques, (e.g., recurrent neural network (RNN), regression), and the physical embodiment of the predictor may exist, for example, as a microcontroller, custom logic in the base layer of the memory device, or as a memristive accelerator.

Memory devices contain sensors that measure physical attributes, such as temperature, while the devices are operational in the field. Sensors for measuring additional attributes, such as voltage, have been published in the literature. Servers also implement ECC for memory and log errors that get detected and corrected while in use. These logs are collected on the device or system where memory is integrated. Additionally, memory vendors perform testing of devices that have been returned to them (i.e., return-to-vendor devices) to assess or determine the root cause of any failures, and also plan to incorporate MBIST capabilities for failure diagnoses in the field.

A method for predicting and managing a device failure includes responsive to a predicted failure of a memory device, the predicted failure based on sensor data associated with the memory device, determining a further action for the memory device.

An apparatus for predicting and managing a device failure includes a memory and a memory controller communicatively coupled with the memory. The memory controller responsive to a predicted failure of a memory device, the predicted failure based on sensor data associated with the memory device, determines a further action for the memory device.

A non-transitory computer-readable medium for predicting and managing a device failure, the non-transitory computer-readable medium having instructions recorded thereon, that when executed by the processor, cause the processor to perform operations. The operations include responsive to a predicted failure of a memory device, the predicted failure based on sensor data associated with the memory device, determining a further action for the memory device.

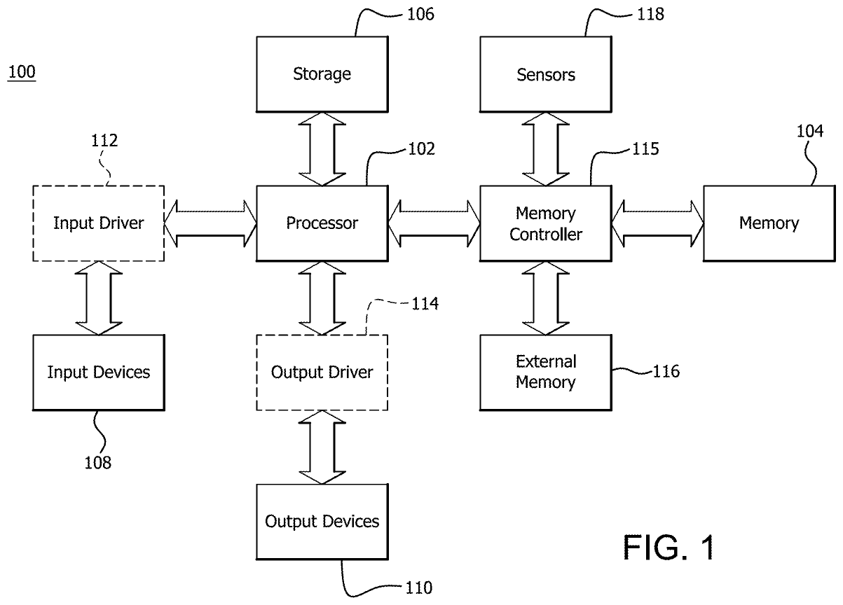

FIG. 1 is a block diagram of an example device 100 in which one or more features of the disclosure can be implemented. The device 100 can include, for example, a computer, a server, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. Additionally, the device 100 includes a memory controller 115 that communicates with the processor 102 and the memory 104, and also can communicate with an external memory 116. In some embodiments, memory controller 115 will be included within processor 102. In addition, the example device 100 includes sensors 118 in communication with the memory controller 115. The sensors 118 may be capable of detecting temperature and/or voltage, for example. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

The external memory 116 may be similar to the memory 104, and may reside in the form of off-chip memory. Additionally, the external memory may be memory resident in a server where the memory controller 115 communicates over a network interface to access the memory 116.

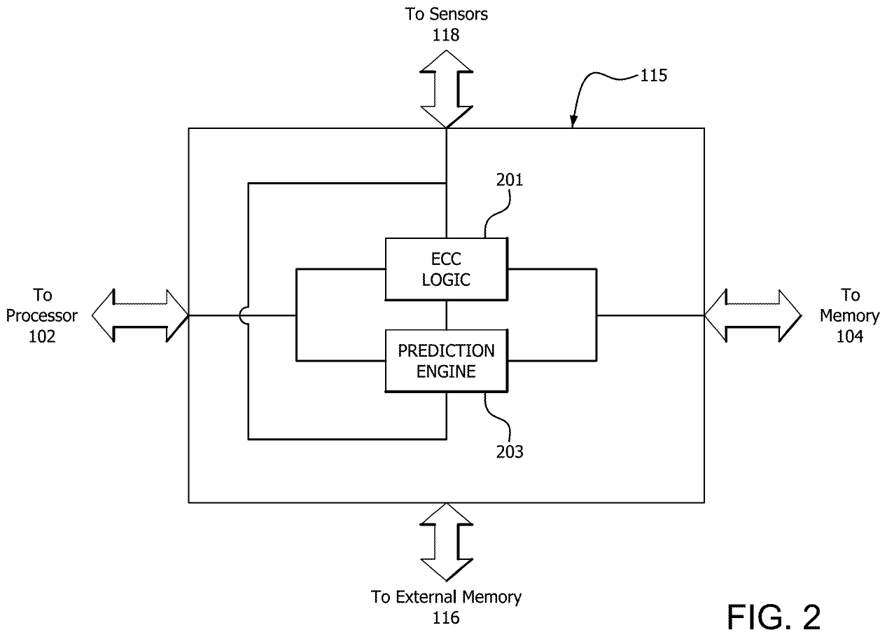

FIG. 2 is a block diagram of an example memory controller 115 in which one or more of the features of the disclosure can be implemented. The memory controller 115 includes ECC logic 201. The ECC logic 201 is in communication with the processor 102, memory 104, external memory 106 and the sensors 118. The ECC logic 201 may be implemented as hardware or software within the memory controller 115. The ECC logic 201 effectively reads cacheline data received to and from the processor 102 and memory, such as memory 104 or external memory 116 and determines whether or not an error has been detected. In addition, the ECC logic 201 may receive sensor data from one or more of the sensors 118 and perform a comparison of that data against predefined data (e.g., a threshold, a set of data points, etc.) to determine if an analysis of the received data exceeds a threshold of the predefined data. As shown in FIG. 2, the ECC logic 201 resides in the memory controller 115. However, it should be noted that the ECC logic 201 may reside elsewhere. Accordingly, the ECC logic 201 may perform the functionality of the method 300 described below. Additionally, the memory controller 115 includes a prediction engine 203, which may be in the form of logic circuitry or a processor, or may also be implemented as other hardware or software within the memory controller 115. The prediction engine 203 is also in communication with the processor 102, memory 104, external memory 106 and the sensors 118, as well as the ECC logic 201, and may receive sensor data from one or more of the sensors 118 and perform a comparison of that data against predefined data (e.g., a threshold, a set of data points, etc.) to determine if an analysis of the received data exceeds a threshold of the predefined data. In addition, although not shown, separate processing logic may be provided in the memory controller 115 or elsewhere in communication with the sensors 118 and the like, in order to receive data (e.g., sensor data) to compare an analysis of such received data against predefined data thresholds

The analysis performed on the received data may include, for example, receiving one or more temperature readings from the sensors 118 and comparing the temperature readings to a threshold temperature that indicates a potential failure temperature of the device. In another example, the one or more voltage readings may be received from the sensors 118 and compared against a threshold voltage, which upon exceeding indicates a potential device failure. Another example set of data is a number of ECC events that are registered by the ECC logic 201. For example, if the number of ECC events exceeds a threshold number of events that indicate that a failure of the device is imminent, a failure may be predicted.

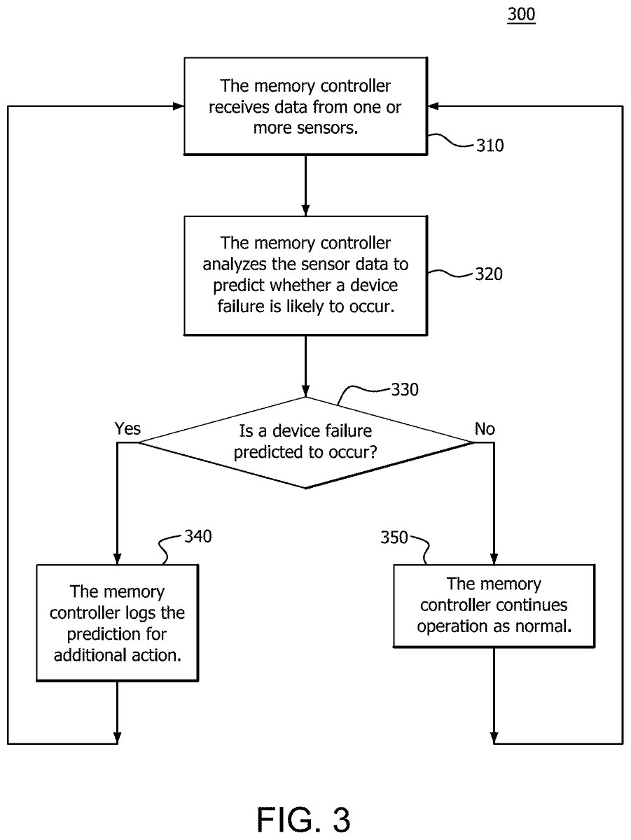

In accordance with the device 100 and memory controller 115 depicted in FIGS. 1 and 2, FIG. 3 is a flow diagram of an example method 300 of fault prediction and management.

In step 310, the memory controller 115 receives data from one or more sensors of the sensors 118. The data received may include temperature data or voltage data, for example. In addition, the data received may include usage data (e.g., latency/bandwidth), and time data (e.g. number of seconds of an operation). The data can be provided from DRAM or the processor 102, for example.

After receiving the data, the memory controller 115 analyzes (by the prediction engine 203) the data to predict whether a failure is likely to occur (step 320). In an exemplary embodiment, the prediction engine may be dedicated logic within ECC logic 201 of controller 115, separate from the ECC logic 201, a general purpose processor executing software or firm or a combination of dedicated logic and general purpose processing as described above in FIG. 2. That is, the memory controller reads the temperature and/or voltage data, for example, to determine whether or not the data meets a criteria to indicate whether or not a failure is likely to occur. Additionally, the memory controller 115 may utilize ECC events that the ECC logic 201 has identified and corrected to determine whether or not a failure is likely to occur. For example, the voltage/temperature may be compared to a pre-determined threshold that determines whether or not a failure is likely to occur. Additionally, a number of ECC events or a type of ECC event may be compared to a threshold number of ECC events or type of ECC events.

In step 330, it is determined whether or not a device failure is predicted to occur. That is, if the temperature, voltage, ECC events, or other received data meet the criteria for a likely predicted failure, it is determined that a failure is likely to occur in step 330.

If it is determined in step 330 that a failure is likely to occur, the memory controller logs the prediction for additional action (step 340). For example, a log of the sensor data and ECC events is created for each identifiable device, (e.g., memory device), in which a failure was predicted to occur. Further, the logs may be uploaded to a central database, (e.g., the vendor database for the device), to track potential failure for action. The action may include providing a firmware update to the memory controller to update events and sensor data to identify more accurately when a device is going to fail. Additionally, the actions may include undertaken RAS actions, such as described above, and for example, post-package repair, or field replaceable unit (FRU) callout. At this point the method reverts to step 310.

If it is determined in step 330 that is not likely to occur, then the memory controller continues normal operation (step 350) and the method reverts to step 310.

The inference engine itself operates in a manner that is opaque to the external interface. That is, when a specific failure mode is predicted, the device may convey this information to the host via logging/transparency mechanisms to trigger any actions to enhance availability and serviceability at the system level (e.g., post-package repair, FRU callout).

A memory vendor may identify newer fault modes based on their evolving dataset and hence may wish update the prediction engine 203 (FIG. 2) while their parts are still in customer systems. Additionally, the prediction engine may be implemented in a processor in memory (PIM). Accordingly the prediction engine/PIM in communication with the host processor via an interface. The new prediction model can be supplied in a suitable format (e.g., a binary) that can be deployed on the PIM via a firmware update at the host.

The methods provided can be implemented in a general purpose computer, a processor, or a processor core. Suitable processors include, by way of example, a general purpose processor, a purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure. Further, although the methods and apparatus described above are described in the context of controlling and configuring PCIe links and ports, the methods and apparatus may be utilized in any interconnect protocol where link width is negotiated.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). For example, the methods described above may be implemented in the processor 102 or on any other processor in the computer system 100.

What is claimed is:

1. A method for predicting and managing a device failure, comprising:
responsive to a predicted failure of a memory device, the predicted failure based on sensor data associated with the memory device, determining by a memory controller a further action for the memory device.

2. The method of claim 1 wherein the predicted failure is based on an analysis of the sensor data and a comparison to a predefined data.

3. The method of claim 1 wherein the sensor data is temperature data.

4. The method of claim 3, further comprising on a condition that the temperature data exceeds a threshold temperature as defined in the predefined data, predicting the device failure.

5. The method of claim 1 wherein the sensor data is voltage data.

6. The method of claim 5, further comprising on a condition that the voltage data exceeds a threshold voltage as defined in the predefined data, predicting the device failure.

7. The method of claim 1 wherein the sensor data is a number of error correcting code (ECC) events.

8. The method of claim 7, further comprising on a condition that the number of ECC events exceeds a threshold number of ECC events as defined in the predefined data, predicting the device failure.

9. The method of claim 1, further comprising logging the sensor data for the device predicted to fail based on a condition that a device failure is predicted.

10. The method of claim 9 further comprising performing remedial action based upon the failure prediction.

11. The method of claim 10 wherein remedial action includes performing a repair of the device predicted to fail.

12. The method of claim 11 wherein the repair includes providing a firmware update to the device predicted to fail.

13. An apparatus for predicting and managing a device failure, comprising:
a memory; and
a memory controller, the memory controller communicatively coupled with the memory,
wherein the memory controller, responsive to a predicted failure of a memory device, the predicted failure based on sensor data associated with the memory device, determines a further action for the memory device.

14. The apparatus of claim 13 wherein the predicted failure is based on an analysis of the sensor data and a comparison to a predefined data

15. The apparatus of claim 13 wherein the sensor data is temperature data.

16. The apparatus of claim 15, further comprising on a condition that the temperature data exceeds a threshold temperature as defined in the predefined data, the memory controller predicts the device failure.

17. The apparatus of claim 13 wherein the sensor data is voltage data.

18. The apparatus of claim 17, further comprising the memory controller predicting the device failure on a condition that the voltage data exceeds a threshold voltage as defined in the predefined data.

19. The apparatus of claim 12 wherein the received data is a number of error correcting code (ECC) events and the memory controller predicting the device failure on a condition that the number of ECC events exceeds a threshold number of ECC events as defined in the predefined data.

20. A non-transitory computer-readable medium for predicting and managing a device failure, the non-transitory computer-readable medium having instructions recorded thereon, that when executed by the processor, cause the processor to perform operations including:
responsive to a predicted failure of a memory device, the predicted failure based on sensor data associated with the memory device, determining a further action for the memory device.
